(19) United States
(12) Patent Application Publication
(10) Pub. No.: US 2006/0021634 A1
(43) Pub. Date: Feb. 2, 2006

(54) Method and apparatus for creating ozonated process solutions having high ozone concentration

(76) Inventors: Zhi (Lewis) Liu, Paoli, PA (US); Richard Novak, Plymouth, MN (US); Alan Walter, Chester Springs, PA (US); Nick Yialamas, Allentown, PA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/177,147

(22) Filed: Jul. 8, 2005

Related U.S. Application Data
(60) Provisional application No. 60/586,194, filed on Jul. 8, 2004.

(51) Int. Cl. B08B 6/00

(52) U.S. Cl. 134/1.3

(57) ABSTRACT

A method and system for creating an ozonated process solution, such as ozonated deionized water, having high ozone concentration. The system comprises, a static mixer coupled to a recirculation loop of an auxiliary tank. The system and method are designed so that during the initial feed of process liquid and ozone gas to the system, the process liquid and ozone gas pass through the static mixer prior to ever reaching the auxiliary. The static mixer mixes the ozone gas into the process liquid to form the ozonated process solution. Thus, the auxiliary tank is initially filled with an ozonated process solution. The ozonated process solution can be recirculated from the auxiliary tank and back through the static mixer while additional ozone gas is dissolved therein. This recirculation can be performed until a desired concentration of ozone is detected in the ozonated process solution.

### CROSS-REFERENCE TO RELATED PATENT APPLICATIONS

The present application claims the benefit of U.S. Provisional Patent Application 60/586,194, filed Jul. 8, 2004, entirety of which is incorporated by reference.

### FIELD OF INVENTION

The present invention relates generally to the field of creating process fluids for the processing of substrates, such as semiconductor processing, and specifically to methods and apparatus for creating ozonated process fluids for said processing. However, the invention can also be applied to the manufacture of raw wafers, lead frames, medical devices, disks and heads, flat panel displays, microelectronic masks, and other applications requiring ozonated process fluids.

### BACKGROUND OF THE INVENTION

Wet processing of electronic components, such as semiconductor wafers, flat panels, and other electronic component precursors is used extensively during the manufacture of integrated circuits. Preferably, wet processing is carried out to prepare the electronic components for processing steps such as diffusion, ion implantation, epitaxial growth, chemical vapor deposition, hemispherical silicon grain growth, or combinations thereof. During wet processing, the electronic components are contacted with a series of processing solutions. The processing solutions may be used, for example, to etch, remove photoresist, clean, grow an oxide layer, or rinse the electronic components.

There are various types of systems available for wet processing of semiconductor wafers. For example, semiconductor wafers may be processed in batch-type process tanks or single-wafer process chambers. In batch-type process, typically, a plurality of semiconductor wafers are submerged in a process solution, or a series of process solutions. In single-wafer processing, a single semiconductor wafer is typically subjected to the process solution via sprayers, but can also be subjected to immersion techniques.

Following processing, the electronic components are typically dried. Drying of the semiconductor substrates can be done using various methods, with the goal being to ensure that there is no contamination created during the drying process. Methods of drying include evaporation, centrifugal force in a spin-rinser-dryer, steam or chemical drying of wafers.

An important consideration for an effective wet processing method is that the electronic component produced by the process be ultraclean (i.e., with minimum particle contamination and minimum chemical residue). An ultraclean electronic component is preferably free of particles, metallic contaminants, organic contaminants, and native oxides; has a smooth surface; and has a hydrogen-terminated surface. Although wet processing methods have been developed to provide relatively clean electronic components, there is always a need for improvement because of the intricacies associated with technological advances in the semiconductor industry. One of the most challenging problems of attaining ultraclean products is the removal of photoresist.

The use of ozonated solutions in semiconductor processing, such as removing organic material/photoresist from semiconductor wafers, has proven to be very useful. For example, U.S. Pat. No. 5,464,480 issued to Matthews (hereinafter “Matthews”), describes a process in which semiconductor wafers are contacted with a solution of ozone and water at a temperature of about 1° C. to about 15° C. Matthews discloses, for example, placing the semiconductor wafers into a tank containing deionized water, diffusing ozone into the deionized water for a time sufficient to oxidize the organic materials from the wafers, while maintaining the temperature of the water at between about 1° C. to about 15° C., and then rinsing the wafers with deionized (DI) water. Matthews further discloses exposing the wafers to ultraviolet light during the process.

Various other methods have been investigated using ozone in conjunction with DI water to strip organic materials from the surface of semiconductor wafers or to rinse wafers after chemical processing. For example, in one such method, ozone gas is generated in an ozone generator and fed to an ozonator where the ozone gas is mixed with DI water. The ozone gas is also simultaneously fed to the bottom of the process vessel via a specially designed device that provides a uniform stream of gaseous ozone into the bath.

In other methods, the use of ozone-injected ultrapure water (ozone concentration of about 1-2 ppm) is applied to the RCA or other similar cleaning methods. The ozonated water is then used to remove organic impurities. The wafers are then treated with NH₄OH and H₂O₂ to remove metallic ion contaminants, followed by a treatment with HF and H₂0₂ to remove native oxide and metal, and to improve surface smoothness. The wafers are then rinsed with DI water. The ozone gas is generated by electrolyzing ultra pure water. The generated ozone gas is then dissolved in ultrapure water through a membrane.

Another method uses a moist ozone gas phase. In this method, a quartz container is filled with a small amount of liquid, sufficient to immerse an O₃ diffuser. The liquid is DI water spiked with additives such as hydrogen peroxide or acetic acid, if appropriate. A lid is placed on the container and the liquid is heated to 80° C. Wafers are placed directly above the liquid interface (i.e., the wafers are not immersed in the liquid). Heating of the liquid in a sealed container and continuous O₃ bubbling through the liquid exposes the wafers to a moist ambient O₃ environment.

Additionally, both spin cleaning techniques using ozonated water and the use of ozone with cleaning solutions have been investigated. Cleaning of semiconductor wafers has also been carried out using gaseous ozone and other chemicals such as hydrofluoric acid and hydrochloric acid to remove residual contaminating particles.

Although the use of ozone has been investigated for use in many semiconductor processing techniques, there are still many drawbacks. For example, it is difficult and/or time consuming to obtain significantly high ozone concentrations using the known processes. This shortcoming is exacerbated when ozone is dissolved in water because the ozone decays very quickly. This decay of ozone can be even further accelerated by such factors as increasing the pH of the solution. Thus, there is a need to provide ozone in a form that is readily deliverable to the surfaces of the electronic components having ozone concentrations that are sufficiently high to effectuate the desired processing.

Additionally, there is the need in the art for a simple and efficient method that permits the safe chemical treatment of electronic components with ozone, while at the same time providing an environmentally safe and economical method.

It is anticipated that as the use of ozonated process fluid in substrate processing continues to increase, so will the demands for systems and methods that can create ozonated process fluids in decreased time.

### SUMMARY OF THE INVENTION

The present invention meets the aforementioned needs, as well as others. For example, in some embodiments, the present invention provides a system and method for creating ozonated process solutions in a stable form. The present invention can be used to create ozonated process solutions having an ozone concentrations that is grater than ozone concentrations formerly achievable. Additionally, such ozonated process solutions can be created in reduced time and with reduced ozone decay rates.

In one aspect, the invention is a system for creating an ozonated process solution comprising: an auxiliary tank having an inlet and an outlet; a recirculation line fluidly connecting the inlet and the outlet, and having a pump for circulating fluids from the outlet to the inlet; a static mixer operably and fluidly connected to the recirculation line; a process liquid supply line fluidly connected to the recirculation line at or upstream of the static mixer; and an ozone gas supply line fluidly connected to the recirculation system at or upstream of the static mixer.

The auxiliary tank is used for holding a stock ozonated process solution that is to be subsequently supplied to a process chamber for substrate processing. The auxiliary tank is operably and fluidly coupled to the recirculation line which also has the static mixer. The pump is provided on the recirculation line for circulating fluids through the recirculation line in a loop-fashion (i.e. from the outlet of the auxiliary tank to the inlet of the auxiliary tank). The static mixer is located between the outlet and inlet of the auxiliary tank. The source of ozone, which can be an ozone generator for example, is fluidly connected to the recirculation line at or upstream of the static mixer via the ozone gas supply line. Similarly, the process liquid reservoir, which can be a DI water reservoir for example, is fluidly connected to the recirculation line at or upstream of the static mixer via the process liquid supply line.

A properly programmed controller can be provided to activate the process liquid supply line and the ozone gas liquid supply line upon receiving a system activation signal from a user. Upon being activated, process liquid and ozone gas will be simultaneously fed into the static mixer before ever reaching the inlet of the auxiliary tank, thereby creating an ozonated process solution. Thus, contrary to existing system and methods which initially fill the auxiliary tank with an un-ozonated process liquid, the auxiliary tank of the present invention is initially supplied (and possibly filled) with an ozonated process solution created by the static mixer. Thus, the present invention significantly reduces ozonated solution preparation times because at no time is pure process liquid supplied to the auxiliary tank which must then be recirculated prior to ever being ozonated.

A fluid level sensor can be supplied in the auxiliary tank to measure the amount of ozonated process solution in the auxiliary tank. Alternatively, other conventional means can be used to measure the amount of liquid in the auxiliary tank. Once a desired amount of ozonated process liquid is created in the static mixer and supplied to the auxiliary tank, the ozone concentration within the ozonated process solution can be increased by terminating the introduction of pure process liquid into the recirculation line and recirculating the ozonated process liquid from the auxiliary tank's outlet, through the static mixer, and back into the auxiliary tank's inlet. Because the supply of ozone gas is continued during the recirculation, additional ozone gas will be introduced into ozonated process solution as it passes through the static mixer. Such recirculation will preferably continue until a desired concentration of ozone is dissolved into the solution. A sensor for measuring the concentration of the ozone in the ozonated process solution can be operably coupled to the recirculation line at or near the outlet of the auxiliary tank. The concentration sensor can be adapted to continually, or periodically, measure the concentration of ozone gas in the ozonated process solution. Signals indicative of the ozone concentration can be transmitted to an electrically coupled controller for analysis. More specifically, the controller can be programmed to compare the signals received from the concentration sensor to a stored desired concentration level. Upon determining that the measured concentration is substantially equal to the desired concentration, appropriate action can be undertaken, as discussed below.

A dispense line is preferably provided to supply prepared ozonated process solution from the auxiliary tank to a process chamber. More preferably, a valve can be coupled to the controller that switches the flow of the ozonated process solution from a path through the recirculation line to a path through the dispense line. This valve can be activated in response to a signal transmitted by the controller that is produced upon the controller determining that the measured concentration is approximately equal to a desired concentration. In a further embodiment, the system can comprise a process chamber supporting at least one semiconductor wafer to be subjected to the ozonated process solution. The process liquid is preferably DI water, but can be any ozonated solution that is used for substrate processing. All processes can be automated by operably coupling the various sensors and valves to a properly programmed controller(s).

In order to reduce the decay rate of the ozone gas from the ozonated process solution before it is used to process a substrate, the auxiliary tank is preferably maintained so as to be under pressure. In one embodiment, this can be accomplished by supplying a pressurized gaseous atmosphere in the auxiliary tank. Most preferably, the gaseous atmosphere consists essentially of nitrogen gas or another inert gas. It has been discovered, that the decay rate of the ozone gas from the ozonated process solution can be further reduced by introducing an amount of carbon dioxide (“CO₂”) into the ozonated process solution. The CO₂ can be added to the ozone gas itself prior to mixing or directly to the ozonated process solution.

The static mixer is preferably of the type that comprises a plurality of baffles adapted to cause turbulent fluid flow within the static mixer, thereby dissolving the ozone in the process liquid. Alternatively, other types of mixers may be used.

In another aspect, the invention is a method of creating an ozonated process solution having a desired ozone concentration. The inventive method comprises the steps of: introducing a process liquid and an ozone gas to a static mixer prior to entering an auxiliary tank; mixing the process liquid and the ozone gas in the static mixer to create an ozonated process solution; providing the ozonated process solution to the auxiliary tank; recirculating ozonated process solution from the auxiliary tank, through the static mixer, and back into the auxiliary tank while continuing to introduce the ozone gas in the static mixer; measuring concentration of ozone gas in the ozonated process solution leaving the auxiliary tank during the recirculation step; and continuing the recirculating step until the measured concentration of ozone gas in the ozonated process solution is substantially equal to the desired concentration.

The method of the invention can further comprise the steps of: measuring the amount of ozonated process solution in the auxiliary tank; and upon a desired amount of ozonated process solution being in the auxiliary tank, ceasing the introduction of the process liquid. In this embodiment, the recirculating step is preferably not undertaken until the desired amount of ozonated process solution is in the auxiliary tank. Alternatively, recirculation can begin immediately.

In another embodiment, the invention can further comprise the step introducing a second gas, such CO2, into the ozonated process solution. The CO₂ can be added to the ozone gas itself prior to mixing or directly to the ozonated process solution.

### BRIEF DESCRIPTION OF THE DRAWING

FIG. 1 is a schematic of a system for creating an ozonated process solution according to an embodiment of the present invention.

FIG. 2 is a comparative graph of ozone concentration vs. ozone sparging time for an embodiment of the invention and a prior art ozone sparging technique.

FIG. 3 is a graph of ozone concentration in DIO₃ solution vs. sparging time showing the results of an experiment according to the present invention for three separate conditions.

FIG. 4 is a comparative graph of ozone concentration in DIO₃ solution vs. sparging time for a condition with CO₂ gas doping and for a condition without CO₂ gas doping.

FIG. 5 graph of ozone concentration in DIO₃ solution vs. sparging time for a single run wherein the DIO₃ creation condition was changed from a condition without CO₂ gas doping to a condition with CO₂ gas doping.

### DETAILED DESCRIPTION OF THE DRAWING

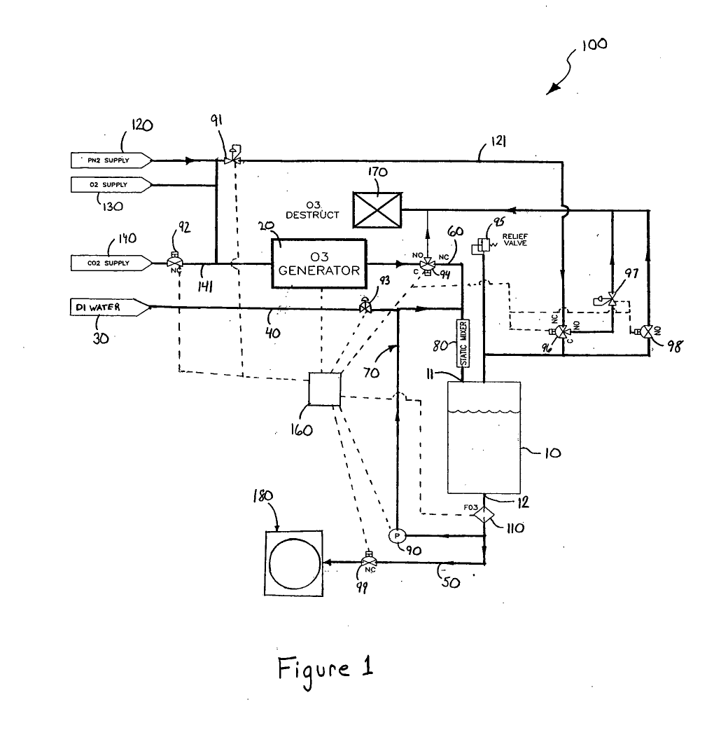

Referring to FIG. 1, ozonated DI water (DIO₃) generator 100 is illustrated according to an embodiment of the present invention. While the invention will be described in detail with respect to the generation of DIO₃, the invention is not so limited and can be used to create any type of ozonated process solution desired.

The DIO₃ generator 100 comprises an auxiliary tank 10, an ozone generator 20, a DI water reservoir 30, a DI water supply line 40, a dispense line 50, an ozone supply line 60, a recirculation loop 70, a static mixer 80, a recirculation pump 90, a concentration sensor 110, a nitrogen gas reservoir 120, oxygen reservoir 130, CO₂ reservoir 140, nitrogen gas supply line 121, a system controller 160, an ozone destruct module 170, process chamber/tank 180, and valves 91-99. While the DIO₃ generator 100 is illustrated as being coupled to a process tank 180, the invention is not so limited. In some aspects, the DIO₃ generator 100 will be a stand alone piece of equipment that can be coupled to a substrate process chamber if desired. All fluid lines, fluid connections, and other hardware are preferably constructed of non-contaminating materials, such as fluoroplymers, when possible. Moreover, all lines fluidly couple the various components of the DIO₃ generator 100 together so that both liquids and/or gases can be flowed through the system without appreciable leaking and/or pressure loss.

All of the valves 91-99 are operably connected to the fluid line on which they are respectively situated. As a result, each valve 91-99 can be independently adjusted between an open position and a closed position so that fluid flow through that respective line can allowed or prohibited as desired during operation of the DIO₃ generator 100. The use and positioning of valves to control fluid flow is common in the art and, thus, the specifics of operation and positioning will not be described in greater detail.

The pump 90 is operably coupled to the recirculation line 70 so that it can circulate fluids through the recirculation line 70 as described below. While only a single pump 90 is illustrated for ease of illustration and to avoid clutter of the illustration, those skilled in the art will appreciate that it may be necessary to incorporate additional pumps into the DIO₃ generator 100 at various positions. For example, individuals pumps may be supplied to each line that is coupled to the reservoirs if desired or on the dispense line 50. The invention is in no way limited to any specific number or placement of pumps. Similarly, mass flow controllers can be added as desired to precisely control the mass flow of the gases and/or liquid throughout the DIO₃ generator 100. Such knowledge is well known in the art. Additional hardware may also include inline heaters, inline chillers, concentration sensors, etc.

The pre-gate cleaning system 100 comprises a properly programmed controller 160 so that the DIO₃ generator 100 can be automated to carry out al functions and process, including the creation of ozonated process solutions according to the method of the present invention. All of the hardware/components of the DIO₃ generator 100 are electrically and operably coupled to the controller 160, such as the valves 91-99, the pump 90, the ozone concentration sensor 110, and any mass flow controllers, inline heaters, inline coolers, and sensors that may be added to the system 100. The system controller 160 can also be coupled to the hardware incorporated into the process tank 180, such as transducers, valves, etc.

The system controller 160 can be a suitable microprocessor based programmable logic controller, personal computer, or the like for process control. The system controller 160 preferably includes various input/output ports used to provide connections to the various components of the pre-gate cleaning system 100 that need to be controlled and/or communicated with. The electrical connections are indicated in dotted line in FIG. 1.

The system controller 160 also preferably comprises sufficient memory to store process recipes and other data, such as thresholds inputted by an operator, processing times, processing conditions, processing temperatures, flow rates, desired concentrations, sequence operations, and the like. The system controller 160 can communicate with the various components of the DIO₃ generator 100 to automatically adjust process conditions, such as temperatures, flow rates, etc. as necessary. The type of system controller used for any given system will depend on the exact needs of the system in which it is incorporated.

The functioning of the DIO₃ generator 100 to produce DIO3 according to an embodiment of the present invention will now be discussed. To start, all valves 91-99 are in the closed position and all pumps are inactive. Upon receiving an initial activation from an operator, the system controller 160 sends an activation signal to the ozone generator 20 to create ozone gas. The ozone gas is created from oxygen that is supplied to the ozone generator 20 from the oxygen reservoir 130. Simultaneously, or soon thereafter, the system controller 160 opens the valve 92 on the CO₂ supply line 141 so that a desired flow rate (mass or volumetric) of CO₂ gas is provided from the CO₂ reservoir 140 to the ozone generator 20. The force necessary to flow the CO₂ gas can be achieved by pressurizing the CO₂ reservoir 140, providing a pump on the CO₂ gas line supply line 141, providing a pressure differential in the line, or by any other means known in the art.

The CO₂ gas is supplied to the ozone generator 20 during the creation of ozone gas. Supplying CO₂ to the ozone gas helps to reduce the decay of the ozone gas from the DIO₃ solution that is later created in the process by acting as an OH radical scavenger. More specifically, adding CO₂ gas in the system reduces the decay of the ozone gas caused by OH radicals that are created when the ozone gas later mixes with the DI water by acting as a scavenger of the OH radicals, thereby prohibiting the OH radicals from breaking down the ozone in chain reactions.

While the CO₂ gas is added directly to the ozone gas as it is created in the ozone generator 20, it is possible for the CO₂ gas to be added at a different location on the DIO₃ generator 100 or at a different point in the process if desired. The CO₂ gas can be added directly to the ozone gas or to the DIO₃ after its formation. For example, the CO₂ gas can be added to the ozone gas supply line 60 downstream of the ozone generator 20, to the DIO₃ after its creation at any point on the recirculation line 70, or to the DIO3 after its creation in the auxiliary rank 10. Finally, it should be noted that while the supply of the CO₂ gas to reduce the decay of the ozone gas from the DIO₃ solution is desired, the invention is not so limited to such an addition.

The system controller 160 then opens the valve 94, thereby allowing the ozone gas (along with the CO₂ gas) to flow through the ozone gas supply line 60 and into the recirculation line 70 at a desired flow rate. The DIO₃ generator 100 is specifically designed so that the ozone gas supply line 60 supplies the ozone gas to the recirculation line 70 at a point upstream of the static mixer 80 and upstream of the auxiliary tank 10. In an alternative embodiment, the DIO₃ generator 100 can be designed to supply the ozone gas directly to the static mixer 80 and upstream of the auxiliary tank 10.

Simultaneously with the opening of the valve 94, the system controller 160 also opens the valve 93, and if necessary activates a pump necessary to withdraw DI water from the reservoir 30 and into the DI water supply line 40. The DIO₃ generator 100 is specifically designed so that the DI water supply line 40 supplies the DI water to the recirculation line 70 at a point upstream of the static mixer 80 and upstream of the auxiliary tank 10. In an alternative embodiment, the DIO₃ generator 100 can be designed to supply the DI water directly to the static mixer 80 and upstream of the auxiliary tank 10.

As a result of opening the valves 93, 94, the DI water and the ozone gas are simultaneously supplied to the recirculation line 70. Upon entering the recirculation line 70, the DI water and ozone gas streams converge prior to the static mixer 80. In an alternative embodiment, the setup of the supply lines 40, 60 can be designed so that DI water and ozone gas streams can converge in the static mixer 80 itself. The combined stream of DI water and ozone gas then flows into the static mixer 80. As the combined stream of DI water and ozone gas (which also includes the CO₂ gas) flow through the static mixer 80, the ozone gas becomes dissolved in the DI water, thereby creating a DIO₃ solution.

Static mixer 80 dissolves the ozone gas into the DI water through the turbulent fluid flow that is caused by baffles arranged within static mixer 80. While a static mixer is preferred, the invention is not so limited and other device can be used dissolve the ozone gas into the DI water if desired, such as a membrane contactor or a bubbler. After being created by the mixing action of static mixer 80, the DIO₃ solution flows into auxiliary tank 10 via the inlet 11. It is important to note that at no time during the process is pure DI water supplied to the auxiliary tank 10. The DIO₃ generator 100 is specifically designed to avoid this condition by ensuring that the initial introduction of DI water into the recirculation loop 70 is ozonated to a certain degree prior ever reaching the auxiliary tank 10.

To reduce and/or eliminate the escape of ozone gas from the DIO₃ solution within auxiliary tank 10, the auxiliary tank 10 is pressurized at this time. In order to achieve this, the system controller opens the valves 91, 96, thereby flowing N₂ gas from the N₂ reservoir 120, through the N₂ supply line 121, and into the auxiliary tank 10. Thus, a pressurized nitrogen gas atmosphere is supplied to auxiliary tank 10, preferably in the range of 60 psi. A relief valve 95 is supplied to ensure that pressure within the auxiliary tank does not become too great.

The DI water and ozone gas continue to be supplied to the recirculation loop 70 as described above until a desired amount of DIO₃ solution is created via static mixer 80 and supplied to auxiliary tank 10. The amount of DIO₃ solution in auxiliary tank 10 can be monitored by a liquid level sensor (not illustrated) that is coupled to and communicates with the system controller 160. Alternatively, mass flow controllers, load cells, etc. can be used to determine how much DIO₃ solution is in the auxiliary tank 10 if desired.

Once the desired amount of DIO₃ solution is produced and provided to the auxiliary tank 10, the system controller 160 closes the valve 93, thereby terminating the flow of the DI water into the recirculation line 70. The ozone gas flow is allowed to continue. Contemporaneously (or at least soon in time) with terminating the DI water supply, the system controller activates pump 90, thereby drawing the DIO₃ solution from the auxiliary tank from the outlet 12. The DIO₃ solution drawn former the outlet 12 is forced back into recirculation line 70 where additional ozone gas is added to the DIO₃ solution prior to the static mixer 80. The DIO₃ solution passes through static mixer 80 once again where the newly added ozone gas is dissolved into the DIO₃ solution, thereby increasing the concentration of the ozone gas in the DIO₃ solution. The DIO₃ solution the flows back into the auxiliary tank 10 for further recirculation if necessary.

Because ozone gas continues to be supplied to the recirculation loop 70 upstream of the static mixer 80 during all recirculation cycles, increased amounts of ozone gas continue to be added to the DIO₃ solution via the mixing action of static mixer 80, thereby continually increasing the concentration of ozone gas in the DIO₃ solution. A concentration sensor 110 is operably coupled to the recirculation loop 70 shortly downstream of the outlet 12 of the auxiliary tank 10. The concentration sensor 110 is operably coupled to the system controller 160 for communication therewith. Concentration sensor 110 can be a conductivity probe or a light-defraction sensor. However, other types of concentration sensors can be used and are known in the art.

During operation, the concentration sensor 110 repetitively measures the concentration of the ozone gas in the DIO3 solution as is passes by. Each time the concentration is measured, the concentration sensor 110 generates a signal indicative of the measured concentration and transmits this signal to the system control 160 for analysis and comparison to stored values that correspond to a desired ozone concentration.

Upon the system controller 160 receiving a signal form the concentration sensor 110 that indicates that the measured ozone concentration of the DIO₃ solution is substantially equal to or greater than the desired ozone concentration, the recirculation of the DIO₃ solution through recirculation line 70 is discontinued by deactivating the pump 90. The system controller 160 also closes the valve 94 at this time, thereby discontinuing the flow of ozone (and CO₂) gas to the recirculation line 70.

If a substrate 181, such as a semiconductor wafer, is positioned in the process chamber 180, and is ready for processing with the DIO₃ solution, the system controller 160 will open valve 99 (and activate a pump if necessary), thereby directing the DIO₃ solution to exit the outlet 12 of auxiliary tank 10 and flow into the dispense line 50. From dispense line 50, the DIO₃ solution is supplied to the process chamber 180 and brought into contact with the at least one substrate 181. The process chamber can be a batch-type process tank or a single-wafer process chamber. Moreover, the invention is not limited to the inclusion of a process chamber at all. The exact temperature and flow characteristics of the DIO₃ solution to the process chamber 180 will be determined on a case-by-case basis and will depend on the nature of the exact process being carried out at that time.

In one embodiment, the oxygen gas supply pressure can be 20 to 60 psi, and preferably about 40 psi. The N₂ gas supply pressure can preferably be 20 to 60 psi, and preferably about 40 psi. The CO₂ gas supply pressure can preferably be 50 to 100 psi, and preferably about 75 psi. The ozone gas supply pressure after the ozone generator can preferably be 20 to 40 psi, and preferably about 31 psi. The ozone generator power can preferably be 98%. The recirculation rate of the DIO₃ solution can preferably be 20 to 40 liters per minute (“lpm”), and more preferably about 31 lpm. The DI water temperature can preferably be 10 to 30° C., and more preferably about 22.5° C. The gas pressure in the recirculation line can preferably be 5 to 15 psi, and more preferably 11 psi. The invention, however, is in no way limited by these parameters. Specific parameters will be determined on a case by case basis, considering such factors as desired ozone concentration, desired DIO₃ creation time, DIO₃ volume needs, etc.

### Experiment

An experiment was carried out by installing the DIO₃ 100 to a single chamber tool to enhance its front end of line cleaning (“FEOL”). The objective of the experiment was: 1) to verify that the module is able to generate 6 gallons of 60 ppm DIO₃ at least; and 2) to evaluate the impact of CO₂ doping on the DIO₃ generation. The setup wit the following parameters.

| Item Description | Set-up Values | |
|---|---|---|
| O₂ gas supply pressure | 40 | psi |
| N₃ gas supply pressure | 40 | psi |
| CO₂ gas supply pressure | 75 | psi |
| O₃ pressure after the generator | 31 | psi |
| GFFOZ reading | 17 | wt % |
| O₃ generator power | 98% | |
| DIO₃ circulating rate | 31 1 | pm |
| | (8.2 | gpm) |
| DI water temperature | 22.5° | C. |
| Gas pressure in the DIO₃ tube | 11 | psi |
| DIO₃ volume in the full tube | 8.6 | gallons |

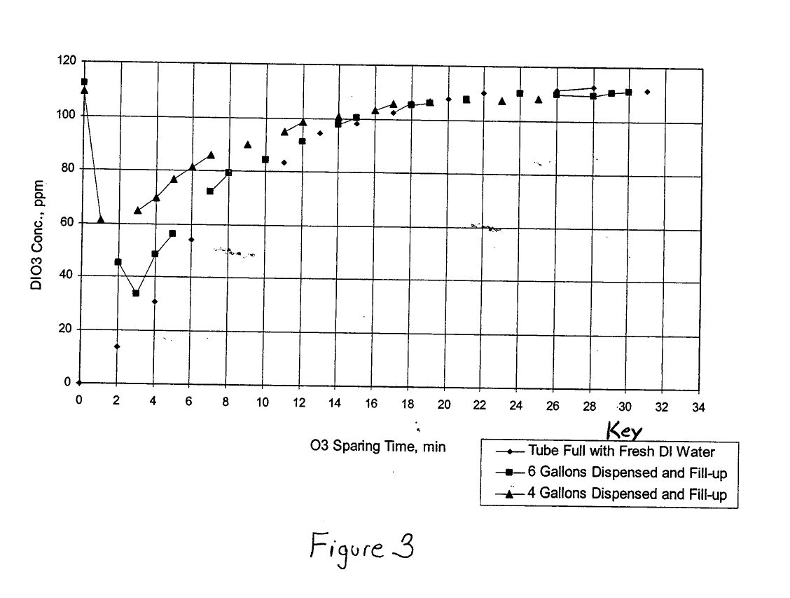

Referring now to FIG. 3, a graph is illustrated that shows the ozone concentration in the DIO₃ solution created vs. ozone gas sparging time for three conditions: (1) with full tube fresh DI water (8.6 gallons); (2) after dispensed 6 gallons of the maximum concentrated DIO₃ and refill-up DI water; and (3) after dispensed 4 gallons of the maximum concentrated DIO₃ and refill-up DI water. From the data plotted, in can be seen that the ozone concentration in the DIO₃ solution created concentration reached above 60 ppm in 8 minutes of O₃ sparging with full fresh DI water (8.6 gallons DI water in the tube). The DIO₃ recovering time for the 4 or 6 gallons dispensed was shorter than 8 minutes. This indicates that the module/invention is able to supply 8.6 gallons of DIO₃ at >60 ppm in 8 minutes. FIG. 3 also shows that the concentration reached 110 ppm in 22 minutes with the tube full.

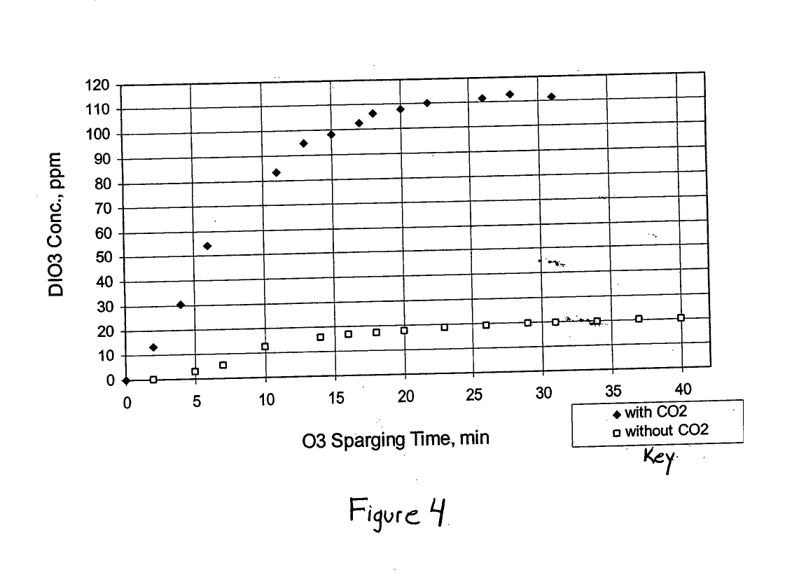

In the module, CO₂ gas was doped into the oxygen being supplied to the ozone generator as described above,. Referring now to FIG. 4, the ozone concentration in the DIO₃ solution created vs. ozone gas sparging time is illustrated for the CO₂ gas doped condition and the condition where no CO₂ gas doping was used. As can be seen, the ozone concentration in the DIO₃ solution reached 110 ppm (the maximum) in 22 minutes with CO2 doping and the concentration without CO₂ doping could not go higher than 20 ppm in 40 minutes. Clearly, the addition of the CO₂ gas is beneficial.

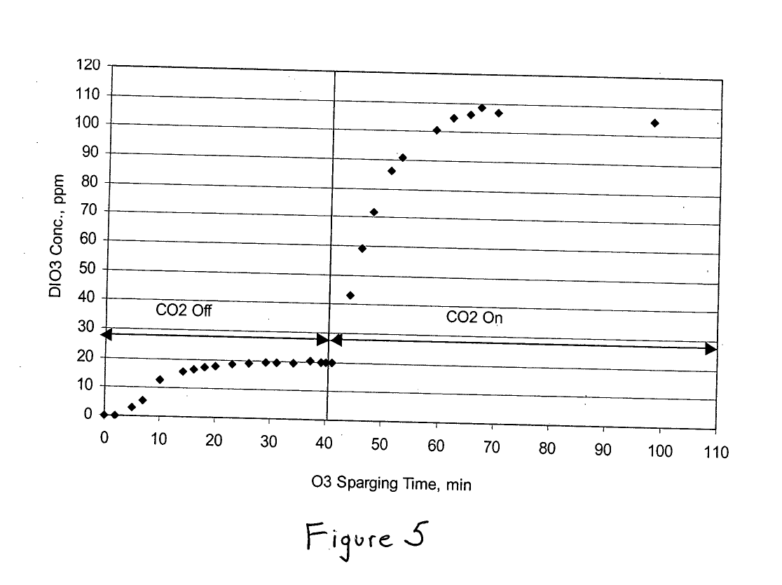

Referring now to FIG. 5, the benefits of CO2 doping are further exemplified. FIG. 5 is graph showing ozone concentration in DIO₃ solution vs. sparging time for a single run wherein the DIO₃ creation condition was changed from a condition without CO₂ gas doping to a condition with CO₂ gas doping.

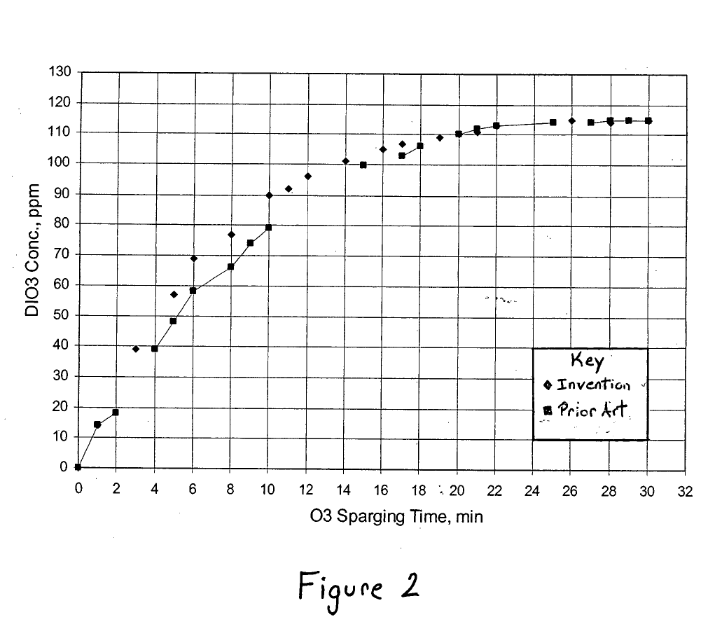

Referring finally to FIG. 2, a comparative graph is illustrated that exemplifies the benefits of the present invention as compared to a prior art DIO₃ creation technique. As can be seen form the graph, the present invention creates DIO3 solution having greater ozone concentration than the prior art system.

While the invention has been described and illustrated in sufficient detail that those skilled in this art can readily make and use it, various alternatives, modifications, and improvements should become readily apparent without departing from the spirit and scope of the invention. Specifically, the ozonated process solutions created using the present invention can be delivered to substrates, such as semiconductor wafer, to effectuate any of a variety of processes including, but not limited to, oxide growth, removal of organic contaminants (e.g., removal of photoresist), pre-cleaning, etching, and cleaning. Thus, the present invention is not limited any specific ozonated process solution, nor is it limited by the type of process the semiconductor wafer is to be subjected to. Moreover, the present invention can be embodied as a stand-alone piece of equipment or can be incorporated into existing processing systems and/or tanks.

What is claimed is:

1. A system for creating an ozonated process solution comprising:
an auxiliary tank having an inlet and an outlet;
a recirculation line fluidly connecting the inlet and the outlet, and having a pump for circulating fluids from the outlet to the inlet;
a static mixer operably and fluidly connected to the recirculation line;
a process liquid supply line fluidly connected to the recirculation line at or upstream of the static mixer; and
an ozone gas supply line fluidly connected to the recirculation system at or upstream of the static mixer.

2. The system of claim 1 further comprising a controller adapted to activate the process liquid supply line and the ozone gas liquid supply line upon receiving a system activation signal so that the auxiliary tank is initially supplied with an ozonated process solution created by the static mixer.

3. The system of claim 2 wherein the controller is further adapted to stop supply of process liquid to the recirculation line upon a desired volume of ozonated process liquid being supplied to the auxiliary tank, the controller further adapted to activate the pump to circulate the ozonated process solution through the recirculation line where additional ozone gas is added via the static mixer.

4. The system of claim 1 further comprising a sensor for measuring ozone concentration, the sensor coupled to the recirculation line.

5. The system of claim 1 further comprising a dispense line for supplying ozonated process solution from the auxiliary tank to a process chamber.

6. The system of claim 5 further comprising valve means for switching flow of the ozonated process solution from through the recirculation line to the dispense line upon a desired concentration of ozone being detected in the ozonated process solution.

7. The system of claim 6 further comprising a process chamber supporting at least one semiconductor wafer to be subjected to the ozonated process liquid.

8. The system of claim 1 wherein the auxiliary tank is under pressure.

9. The system of claim 8 wherein the auxiliary tank comprises a pressurized gaseous atmosphere.

10. The system of claim 9 wherein the gaseous atmosphere consists essentially of nitrogen gas.

11. The system of claim 1 further comprising a liquid level sensor positioned in the auxiliary tank for measuring the amount of ozonated process solution in the auxiliary tank.

12. The system of claim 1 wherein the process liquid is DI water, the system further comprising a DI water reservoir.

13. The system of claim 1 further comprising a source of ozone.

14. The system of claim 13 wherein the source of ozone is an ozone generator.

15. The system of claim 14 further comprising a source of carbon dioxide fluidly connect to the ozone generator.

16. The system of claim 1 wherein the static mixer comprises a plurality of baffles adapted to cause turbulent fluid flow within the static mixer.

17. A method for creating an ozonated process solution having a desired ozone concentration comprising:
introducing a process liquid and an ozone gas to a static mixer prior to entering an auxiliary tank;
mixing the process liquid and the ozone gas in the static mixer to create an ozonated process solution;
providing the ozonated process solution to the auxiliary tank;
recirculating ozonated process solution from the auxiliary tank, through the static mixer, and back into the auxiliary tank while continuing to introduce the ozone gas in the static mixer;
measuring concentration of ozone gas in the ozonated process solution leaving the auxiliary tank during the recirculation step; and
continuing the recirculating step until the measured concentration of ozone gas in the ozonated process solution is equal to the desired concentration.

18. The method of claim 17 further comprising:
measuring the amount of ozonated process solution in the auxiliary tank; and
upon a desired amount of ozonated process solution being in the auxiliary tank, ceasing the introduction of the process liquid.

19. The method of claim 17 wherein the process liquid is DI water.

20. The method of claim 17 further comprising:
measuring the amount of ozonated process solution provided to the auxiliary tank during the providing step; and
upon a desired amount of ozonated process solution being in the auxiliary tank, ceasing the introduction of the process liquid;
wherein the recirculating step is not undertaken until the desired amount of ozonated process solution is in the auxiliary tank.

21. The method of claim 17 further comprising:
creating the ozone gas prior to the introduction with an ozone generator.

22. The method of claim 17 wherein the auxiliary tank is under pressure.

23. The method of claim 22 further comprising providing a pressurized gaseous atmosphere in the auxiliary tank.

24. The method of claim 23 wherein the gaseous atmosphere consists essentially of nitrogen gas.

25. The method of claim 17 further comprising the step of introducing carbon dioxide gas with the ozone gas.
